(19) United States
(12) Patent Application Publication
(10) Pub. No.: US 2013/0157246 A1
(43) Pub. Date: Jun. 20, 2013

(54) REMOVABLE DRY ERASE BOARD

(71) Applicant: David V. Shapiro, Northbrook, IL (US)

(72) Inventor: David V. Shapiro, Northbrook, IL (US)

(21) Appl. No.: 13/331,811

(22) Filed: Dec. 20, 2011

(51) Int. Cl. B43L 1/00

(52) U.S. Cl. 434/408

(57) ABSTRACT

A writing board including a flexible board having a front dry-erase surface and a rear surface within an outer boundary, and an adhesive layer having a first side adhered to the rear surface of the flexible board and a second, opposite side having a re-adherable and releasable adhesive. The adhesive layer extends to the outer boundary of the flexible board except in a selected area, and a visible indicator is on the flexible board front surface and overlies the selected area. The adhesive layer has a thickness between the first and second sides whereby the selected area of the flexible board is spaced by substantially that thickness from a surface to which the flexible board is adhered.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates to writable boards, and more particularly to movable dry-erase boards.

### BACKGROUND OF THE INVENTION

Notwithstanding the digital age in which information may be transmitted, it is still common, convenient and inexpensive to write information on surfaces, whether to transmit information to others or to memorialize or remind the writer of that information.

A typical instance in which such information is written down is to leave written notes on a surface at a location where they will likely be noticed by the intended recipient.

One common manner in which this is done is to write on sheets of paper having adhesive on the back side to allow the paper to be stuck at a desired location. One well known product usable in such a manner are Post-It™ Notes by 3M, which are generally small squares of paper having a strip of releasable, re-adherable adhesive along one side of the paper. While such products are well suited for some uses, such as on the side of a computer monitor or as tabs for pages of a book, etc., they can be unsightly and multiple bits of information can go unnoticed and/or get lost in the clutter of multiple paper sheets stuck in an area. Further, such sheets are typically written in one location and then stuck up in the desired location, often resulting in no note being left when the person desiring to write the note cannot find the paper. Still further, while it would be possible to leave Post-It™ type notes stuck up at a location (e.g., on a wall) and write on the sheet of paper in place, resulting in a risk of scarring the wall behind the sheet of paper, whether by bleeding through the papers, or even leaving indentations in the wall if any pressure is used in writing the note (e.g., with a ball point pen). This risk is exacerbated by the fact that the sheets are “paper thin”, not only for ease of intended use but also because thicker, stiff material would make the notes difficult to grasp to remove from a location. Further still, since such sheets are typically discarded without being reused, they require that a stack of such sheets be kept in the area where it is desired to leave a note. If the sheets run out, or are misplaced, it may not be possible for a person to leave any note at the desired location.

Still other methods of leaving notes have been used. For example, dry erase boards have been mounted to walls at permanent locations in high traffic areas (e.g., in work areas, or in homes in foyers by entrance doors to homes). Such boards have the advantage of being readily reusable (by erasing old information/notes and writing new information/notes in the erased area), making them more environmentally sustainable. Also, such boards are always available for use in their permanent location, and their stiffness allows writing to be done in place without worry that the underlying surface might be scarred. Further, such boards are locatable on vertical surfaces such as walls where they will be readily noticed by people who pass the board without giving the appearance of clutter and/or causing information to be missed as readily as would occur with multiple PostIt™ type notes. Unfortunately, while such boards may allow for advantageous features as noted above, they are typically fixed in place and do not allow their location to be easily changed.

The present invention is directed to overcoming one or more of the problems set forth above.

### SUMMARY OF THE INVENTION

In one aspect of the present invention, a writing board is provided, including a flexible board having a front dry-erase surface and a rear surface within an outer boundary, and an adhesive layer having a first side adhered to the rear surface of the flexible board and a second, opposite side having a re-adherable and releasable adhesive. The adhesive layer extends to the outer boundary of the flexible board except in a selected area. The adhesive layer has a thickness between the first and second sides whereby the selected area of the flexible board is spaced by substantially that thickness from a surface to which the flexible board is adhered.

In one form of this aspect of the present invention, the board front surface is substantially blank except for a visible indicator on the flexible board front surface overlying said selected area. In a further form, the board front surface is substantially blank except for the visible indicator which includes an outline on the board front surface corresponding to the outer edges of the selected area. In another further form, the visible indicator includes a lift indicator indicating that the board may be lifted at the selected area from a surface to which it is adhered.

In another form of this aspect for the present invention, the adhesive layer is at least about 1 mm thick, whereby when the flexible board is adhered to a support surface with the selected area of the flexible board spaced at least about 1 mm from the support surface. In a further form, the adhesive layer is a thermoplastic elastomer and the flexible board is polyethylene terephthalate. In a still further form, the flexible board is about 0.2 mm thick.

In still another form of this aspect of the present invention, a writable surface is provided with the writing board releasably adhered to a flat wall, wherein the flexible board is substantially flat in an unflexed configuration. In a further form, the adhesive layer is at least about 1 mm thick, whereby the flexible board selected area is substantially parallel to and spaced from the flat wall at least about 1 mm. In another further form, the flexible board is sufficiently stiff that it will not fold when the selected area is lifted from the wall by application of a bending force, and sufficiently elastic to return to its substantially flat configuration when the bending force is released.

In another aspect of the present invention, a selectively movable writable surface is provided, including a flat support surface, and a re-adherable writing board releasably adhered thereto. The writing board includes a flexible rectangular board having a substantially blank front surface and a rear surface within an outer boundary, and a thermoplastic elastomer adhesive layer having a first side adhered to the rear surface of the flexible board and a second, opposite side having a re-adherable and releasable adhesive. The flexible board is substantially flat in an unflexed configuration and the front surface is a polyethylene terephthalate dry-erase surface. The adhesive layer extends to the outer boundary of the flexible board except in a selected corner area of the board. The adhesive layer has a thickness between the first and second sides whereby the selected area of the flexible board is spaced by substantially that thickness from the support surface to which the flexible board is adhered.

In one form of this aspect of the present invention, a visible indicator is on the flexible board front surface and overlies the selected corner area, with visible marks distinguishing the corner area from the remainder of the board front surface. In a further form, the visible indicator includes an outline on the board front surface corresponding to the outer edges of the selected corner area. In another further form, the visible indicator includes a lift indicator indicating that the board may be lifted at the selected area from the support surface.

In another form of this aspect for the present invention, the flexible board is about 0.2 mm thick and the adhesive layer is at least about 1 mm thick whereby the flexible board selected corner area is substantially parallel to and spaced from the flat support surface at least about 1 mm.

In another form of this aspect of the present invention, the flexible board is sufficiently stiff that it will not fold when the selected area is lifted from the support surface by application of a bending force, and sufficiently elastic to return to its substantially flat configuration when the bending force is released.

In still another aspect of the present invention, a writing board kit is provided including a flat display panel, a plurality of writing boards secured to the face of the display panel, and a dry erase pen secured to the flat display panel by a re-adherable and releasable adhesive. The writing boards each include a flexible board having a front dry-erase surface and a rear surface within an outer boundary, and an adhesive layer having a first side adhered to the rear surface of the flexible board and a second, opposite side having a re-adherable and releasable adhesive. The adhesive layers extend to the outer boundaries of the flexible boards except in selected areas, and visible indicators are on the flexible board front surface and overlie the selected areas. The adhesive layers have a thickness between the first and second sides whereby the selected areas of the flexible boards are spaced by substantially that thickness from the flat display panel.

In one form of this aspect of the present invention, the board front surfaces are substantially blank except for the visible indicators which include outlines on the board front surfaces corresponding to the outer edges of the selected areas. In a further form, each of the visible indicator includes a lift indicator indicating that the board may be lifted at the selected area from a surface to which it is adhered.

In another form of this aspect for the present invention, the adhesive layers are at least about 1 mm thick, whereby when the flexible boards are adhered to a support surface with the selected areas of the flexible boards spaced at least about 1mm from the display panel. In a further form, the adhesive layers are thermoplastic elastomer and the flexible boards are polyethylene terephthalate. In a still further form, the flexible boards are about 0.2 mm thick.

Other objects, features, and advantages of the invention will become apparent from a review of the entire specification, including the appended claims and drawings.

### BRIEF DESCRIPTION OF THE DRAWINGS

FIG. 1 is a perspective view of a kit of writing boards and a writing instrument according to one aspect of the present invention;

FIG. 2 is a cross-sectional view taken along line 2-2 of FIG. 1;

FIG. 3 is a cross-sectional view similar to FIG. 2, illustrating the writing board being removed from the kit;

FIG. 4 is a partial perspective view of a portion of the FIG. 1 kit;

FIG. 5 is a view similar to FIG. 4, illustrating one of the writing boards being removed as also illustrated in FIG. 3;

FIG. 6 is a cross-sectional view of one writing board according to FIG. 1 as attached to a wall; and

FIG. 7 is a side view of the kit of FIG. 1.

### DETAILED DESCRIPTION OF THE PREFERRED EMBODIMENT

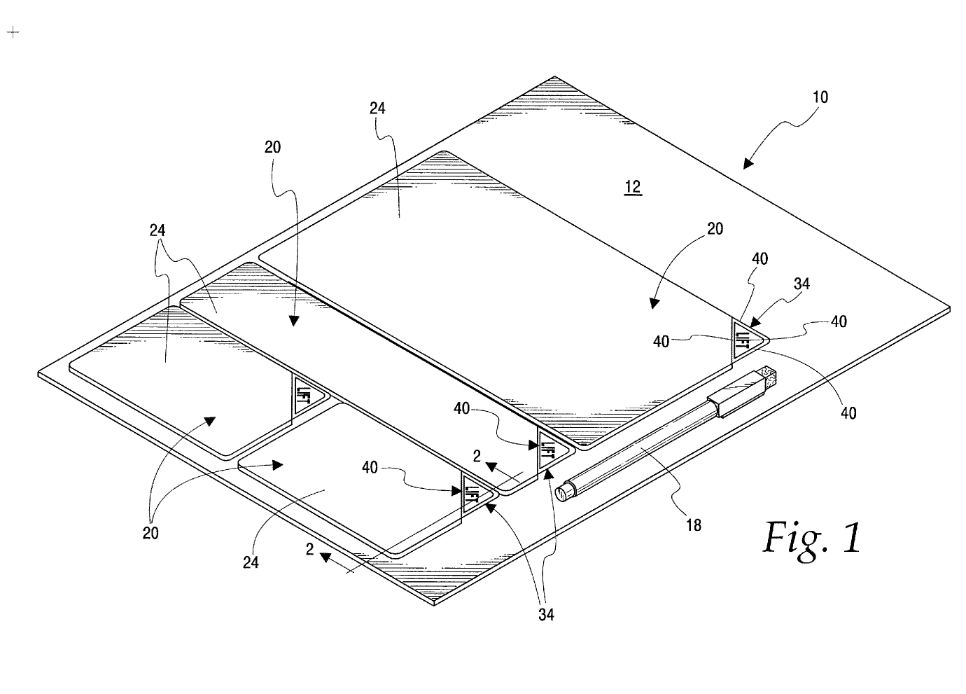

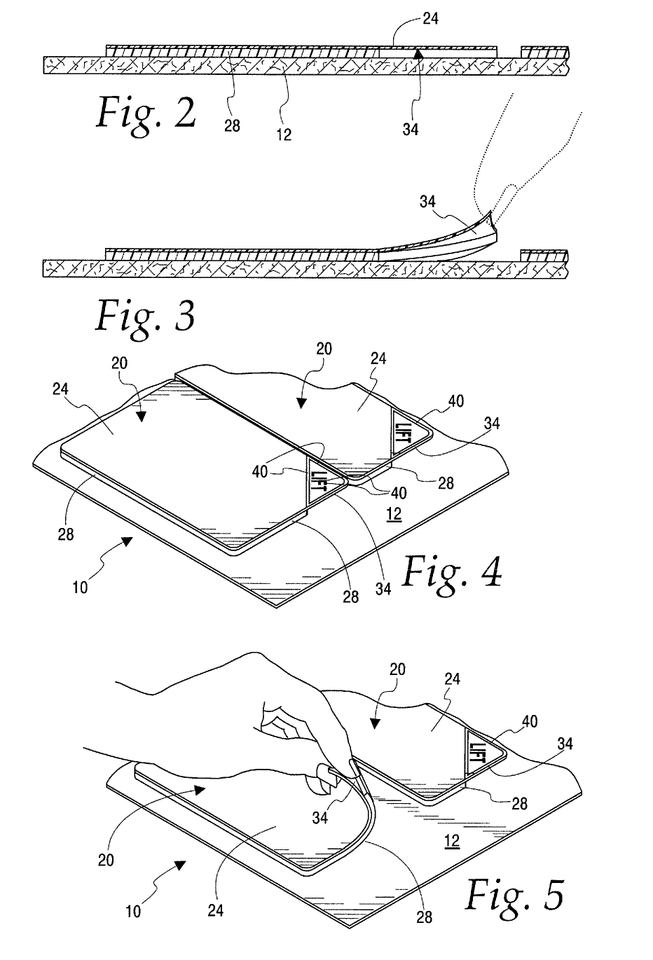

FIG. 1 illustrates a kit 10 incorporating various aspects of the present invention, wherein the kit 10 includes a flat display panel 14 to which a dry-erase pen 18 and a plurality of writing boards 20 are adhered.

In the illustrated kit 10, four different writing boards 20 are provided, with the boards 20 being generally rectangular and of varying sizes. It should be appreciated that writing boards 20 having different shapes and sizes could be used within the broad scope of the invention. Writing boards 20 embodying aspects of the present invention include a flexible board 24 and an adhesive layer 28.

In an advantageous form, the writing boards 20 have a front surface which is a dry erase surface (Le., have a smooth texture such as is known whereby dry erase pens 18 will readily write on the surface, which writing may be erased from the surface with a dry eraser).

The adhesive layer 28 is secured to the rear surface of the writing boards 20. The other, opposite surface of the adhesive layer 28 has a surface adhesive which is both releasable and re-adherable. The relative adhesion between the rear surface of the writing board 20 and the adhesive layer 28 is greater than the adhesion which the opposite surface of the adhesive layer 28 has to a surface to which it is adhered (e.g., the display panel 14, or a wall) so that when the writing board 20 is pulled away from such a surface, the adhesive layer 28 will release from the surface and remain adhered to the flexible board 24.

A dry erase pen 18 may also include a releasable adhesive 30 (see FIG. 7) to allow it to be adhered to the display panel 12 of the kit 10, as well as to be adhered in the location of one of the writing boards 20 (whether by adhering on the writing board 20 itself or next to the writing board 20 on the surface to which the writing board 20 is adhered). The pen 18 may also include a dry eraser 32 such as is known for inclusion with such pens 18.

In accordance with the present invention, the adhesive layer 28 does not fully cover the rear surface of the flexible board 24, so that a selected area 34 of the board 24 has no adhesive layer 28 thereon. In the illustrated rectangular boards, the area 34 is a corner of each board 24. It should be appreciated, however, that it would be within the broad scope of some aspects of the present invention for the area 34 to include one or more areas around the edge of the flexible board 24, and could in one form be an area which consists of the edge for a short width around the entire boundary of the flexible board 24. In any form, however, the vast majority of rear surface of the flexible board 24 has the adhesive layer 28 adhered thereto.

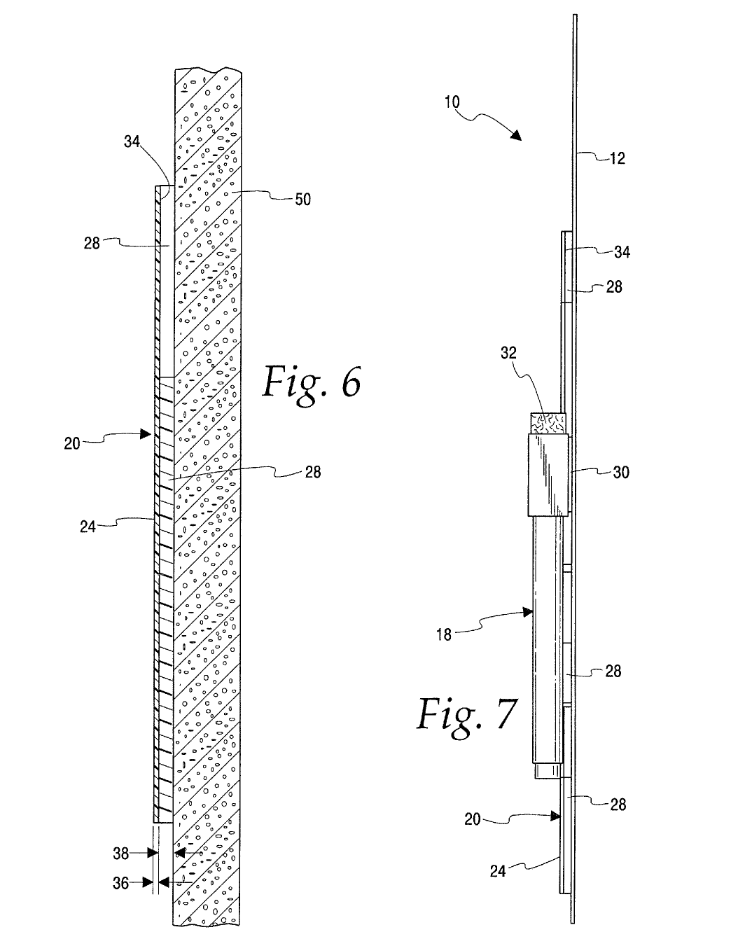

In one advantageous form, the writing board 20 maybe be formed of a flexible board 24 made of polyethylene terephthalate having a thickness 36 (see FIG. 6) of about 0.2 mm, and an adhesive layer 28 made of thermoplastic elastomer having a thickness 38 of about 1 mm (e.g., 1.1 mm). Such an adhesive layer 28 will not only releasably adhere to another surface, but it can be re-adhered to a different surface repeatedly. While the layer 28 may lose some stickiness over the course of use due to dirt and other particles sticking to the layer 28, a wet rag can typically be used to wash those particles from the layer 28 to substantially return it to its original stickiness whereby it can be adhered to other surfaces as desired. Further, it should be appreciated that such a writing board 20 will thus cause the selected area 34 of the flexible board 24 to be spaced about 1 mm from whatever surface to which it is adhered. It should be appreciated that this spacing will facilitate removal of the writing board 20 from an underlying surface as detailed herein below.

The front surface of the flexible board 24 is substantially blank (e.g., a solid white color) to allow for writing, except for a visible indicator 40 which highlights the selected area 34 around the boundary of the flexible board 24. Advantageously, the visible indicator 40 can include an outline of the area 34 in a dark color, and a visible indication (e.g., the word “LIFT”) that the flexible board 24 may be lifted at that area as described below.

It should thus be appreciated that the writing boards 20 may be removed from the display panel 12 by a user reaching under the flexible board 24 at the selected area 34, such as shown in FIGS. 3 and 5. While the flexible boards 24 of the writing boards 20 are substantially flat and stiff, they are also flexible enough so that they will flex or bend (but not fold beyond an elastic limit) with application of a bending force such as occurs when a person reaches under the flexible board 24 at the selected area 34. A user may thus in this manner begin pulling the writing board 20 free from the surface to which it is adhered (e.g., the display panel 12), with continued pulling up of that area 34 causing the adhesive layer 28 to release from the surface and peel off of the surface. Further, the flexible board 24 and adhesive layer 28 have sufficient elasticity so that they will return to their substantially flat configuration when the bending force is released, thereby allowing the flat writing board 20 to be removed from one surface and/or location and re-adhered at another location (e.g., from the display panel 12 to a wall 50 [see FIG. 6], and from the wall 50 to another location on the wall or another wall, etc.).

Moreover, it should be appreciated that the visible indicator 40 not only causes the writing board 20 to be very user friendly when moving the writing board 20 from one surface to the next, but it also helps to ensure that the user will attempt to lift the flexible board 24 at the proper location (as opposed to trying to slide a fingernail under the adhesive layer 28 at the boundary of the flexible board 24, which could potentially cause the adhesive layer 28 to be damaged and limit the ability to reuse the writing board in different locations).

Still further, it should be appreciated that the combination of the relative stiffness and hardness of the flexible board 24 with the cushion and thickness of the adhesive layer 28 will enable a person to write a message on the front surface of the flexible board 24 without concern that the message will bleed through to the underlying surface, or that pressure of the writing instrument when writing will be sufficient to mar the underlying surface,

In short, kits 10 of writing boards 20 according to the present invention, and the writing boards 20 themselves, provide an ideal product whereby a user may easily place a board 20 for leaving written messages in virtually any convenient and easily usable location, and may as easily move the board 20 to a different location thereafter if desired, and may do so without concern that the boards 20, or use of the boards 20, will damage the location. Further the boards 20 are reusable so that, particularly as opposed to PostIt™ type notes which result in large amounts of scrap paper, they are environmentally sustainable.

1. A writing board, comprising:
a flexible board having a front surface and a rear surface within an outer boundary, said front surface being a dry-erase surface; and
an adhesive layer having a first side adhered to the rear surface of the flexible board and a second, opposite side having a re-adherable and releasable adhesive, said adhesive layer extending to the outer boundary of the flexible board except in a selected area;
wherein said adhesive layer has a thickness between said first and second sides whereby said selected area of said flexible board is spaced by substantially said thickness from a surface to which the flexible board is adhered.

2. The writing board of claim 1, wherein said board front surface is substantially blank except for a visible indicator on said flexible board front surface overlying said selected area.

3. The writing board of claim 2, wherein the visible indicator includes an outline on said board front surface corresponding to the outer edges of the selected area.

4. The writing board of claim 2, wherein said visible indicator includes a lift indicator indicating that said board may be lifted at the selected area from a surface to which it is adhered.

5. The writing board of claim 1, wherein said adhesive layer is at least about 1 mm thick, whereby when said flexible board is adhered to a support surface, said selected area of said flexible board is spaced at least about 1 mm from said support surface.

6. The writing board of claim 5, wherein said adhesive layer is a thermoplastic elastomer and said flexible board is polyethylene terephthalate.

7. The writing board of claim 6, wherein said flexible board is about 0.2 mm thick.

8. A writable surface comprising:
a flat wall; and
the writing board of claim 1 releasably adhered to said wall, wherein said flexible board is substantially flat in an unflexed configuration.

9. The writable surface of claim 8, wherein said adhesive layer is at least about 1 mm thick, whereby said flexible board selected area is substantially parallel to and spaced from said flat wall at least about 1 mm.

10. The writable surface of claim 8, wherein said flexible board is sufficiently stiff that it will not fold when said selected area is lifted from said wall by application of a bending force, and sufficiently elastic to return to its substantially flat configuration when the bending force is released.

11. A selectively movable writable surface, comprising:
a flat support surface; and
a re-adherable writing board, including
a flexible rectangular board having a substantially blank front surface and a rear surface within an outer boundary, said front surface being a polyethylene terephthalate dry-erase surface, wherein said flexible board is substantially flat in an unflexed configuration, and
a thermoplastic elastomer adhesive layer having a first side adhered to the rear surface of the flexible board and a second, opposite side having a re-adherable and releasable adhesive, said adhesive layer extending to the outer boundary of the flexible board except in a selected corner area of said board;
wherein said adhesive layer has a thickness between said first and second sides whereby said selected area of said flexible board is spaced by substantially said thickness from the support surface to which the flexible board is adhered.

12. The writable surface of claim 11, further comprising a visible indicator on said flexible board front surface and overlying said selected corner area, said visible indicator including visible marks distinguishing said corner area from the remainder of said board front surface said visible indicator.

13. The writable surface of claim 12, wherein the visible indicator includes an outline on said board front surface corresponding to the outer edges of the selected corner area.

14. The writable surface of claim 12, wherein said visible indicator includes a lift indicator indicating that said board may be lifted at the selected corner area from the support surface.

15. The writable surface of claim 11, wherein said flexible board is about 0.2 mm thick and said adhesive layer is at least about 1 mm thick, whereby said flexible board selected corner area is substantially parallel to and spaced from said flat support surface at least about 1 mm.

16. The writable surface of claim 11, wherein said flexible board is sufficiently stiff that it will not fold when said selected area is lifted from said support surface by application of a bending force, and sufficiently elastic to return to its substantially flat configuration when the bending force is released.

17. A writing board kit, comprising:
a flat display panel;
a plurality of writing boards secured to the face of said display panel, said writing board each including:
a flexible board having a front surface and a rear surface within an outer boundary, said front surface being a dry-erase surface,
an adhesive layer having a first side adhered to the rear surface of the flexible board and a second, opposite side having a re-adherable and releasable adhesive, said adhesive layer extending to the outer boundary of the flexible board except in a selected area, and
a visible indicator on said flexible board front surface and overlying said selected area,
wherein said adhesive layer has a thickness between said first and second sides whereby said selected area of said flexible board is spaced by substantially said thickness from the flat display panel; and
a dry erase pen secured to said flat display panel by a re-adherable and releasable adhesive.

18. The writing board kit of claim 17, wherein said front surface of each of said writing boards is substantially blank except for the visible indicator which includes an outline on said board front surface corresponding to the outer edges of the selected area.

19. The writing board kit of claim 18, wherein each of said visible indicators includes a lift indicator indicating that said board may be lifted at the selected area from a surface to which it is adhered.

20. The writing board kit of claim 17, wherein each of said adhesive layers are at least about 1 mm thick, whereby said selected areas of said flexible boards are spaced at least about 1 mm from said display panel.

21. The writing board kit of claim 20, wherein said adhesive layers are a thermoplastic elastomer and said flexible boards are polyethylene terephthalate.

22. The writing board kit of claim 21, wherein said flexible boards are about 0.2 mm thick.
